(19) United States
(12) Patent Application Publication
(10) Pub. No.: US 2014/0055684 A1
(43) Pub. Date: Feb. 27, 2014

(54) LIQUID CRYSTAL DISPLAY APPARATUS AND LIQUID CRYSTAL PROJECTOR

(71) Applicant: Sony Corporation, Tokyo (JP)

(72) Inventors: Shinpei Murasaki, Kumamoto (JP); Hideaki Ishii, Kumamoto (JP)

(73) Assignee: Sony Corporation, Tokyo (JP)

(21) Appl. No.: 13/967,452

(22) Filed: Aug. 15, 2013

(30) Foreign Application Priority Data
Aug. 22, 2012 (JP) 2012-183119

(51) Int. Cl. G02F 1/1335

(52) U.S. Cl. CPC G02F 1/133512
USPC 349/5; 349/110

(57) ABSTRACT

Provided is a liquid crystal display apparatus including first and second substrates configured to be arranged so as to face each other, a vertical-orientation-type liquid crystal layer configured to be enclosed between the first and second substrates, pixel electrodes configured to be installed on a side of the liquid crystal layer on the first substrate, an orientation film configured to be installed so as to cover the side of the liquid crystal layer of the pixel electrodes and to have a predetermined orientation restriction direction, and a surface light-blocking layer configured to be installed on a lower layer of an area between the pixel electrodes, to be installed along a side in which a normal line direction and the orientation restriction direction of the orientation film are different by 90 degrees or more, and to be set to a same potential as the pixel electrode.

### BACKGROUND

The present disclosure relates to a liquid crystal display apparatus and a liquid crystal projector.

In the related art, for example, following Japanese Patent Laid-Open No. 2005-274665 discloses a liquid crystal display apparatus of a general projection type and reflection type. Also, Japanese Patent Laid-Open No. H7-301814 discloses a technique assuming that a domain originating in a horizontal electric field between adjacent pixel electrodes is improved by setting up a compensation electrode in the lower layer of pixel electrode and generating a longitudinal electric field between opposing common electrodes in TN-LCD.

### SUMMARY

In a liquid crystal display of a vertical orientation type (i.e. VA scheme), the liquid crystal orientation restriction force in the horizontal direction (i.e. in-plane direction) is a small. Therefore, in the liquid crystal display of the vertical orientation type, since the orientation azimuth shifts from an intended angle due to the horizontal potential difference between adjacent pixels to which different potentials are applied, a problem that a disclination is generated unfortunately occurs.

The technique disclosed in Japanese Patent Laid-Open No. H7-301814 relates to the TN orientation and is not assumed to be applied to a liquid crystal display of a vertical orientation type (VA). Also, in technique disclosed in Japanese Patent Laid-Open No. H7-301814, since it is requested to set up a compensation electrode, a problem that the space increases and the manufacturing cost increases unfortunately occurs.

Therefore, by a simple configuration, it is requested to reduce the generation area of orientation abnormality due to a horizontal electric field from an adjacent pixel and realize display of high display grade.

According to an embodiment of the present disclosure, there is provided a liquid crystal display apparatus including first and second substrates configured to be arranged in a manner that the first and second substrates face each other, a vertical-orientation-type liquid crystal layer configured to be enclosed between the first and second substrates, pixel electrodes configured to be installed on a side of the liquid crystal layer on the first substrate, an orientation film configured to be installed in a manner that the orientation film covers the side of the liquid crystal layer of the pixel electrodes and has a predetermined orientation restriction direction, and a surface light-blocking layer configured to be installed on a lower layer of an area between the pixel electrodes which are adjacent to each other, to be installed along a side in which a normal line direction, which is set on a side of one of the pixel electrodes and directed to a center of the pixel electrode, and the orientation restriction direction of the orientation film are different by 90 degrees or more, and to be set to a same potential as the pixel electrode.

Further, the surface light-blocking layer may be installed in an L-shaped manner along two sides in which the normal line direction and the orientation restriction direction are different by 90 degrees or more.

Further, according to an embodiment of the present disclosure, there is provided a liquid crystal projector including the liquid crystal display apparatus according, the liquid crystal display apparatus supporting each of red, green and blue colors.

According to embodiments of the present disclosure, by a simple configuration, it is possible to reduce the generation area of orientation abnormality due to a horizontal electric field from an adjacent pixel and realize display of high display grade.

### BRIEF DESCRIPTION OF THE DRAWINGS

FIG. 1 a rough cross-sectional view indicating a configuration of a liquid crystal display apparatus according to an embodiment of the present disclosure;

FIG. 2 is a view indicating field distribution and a plane view and cross-sectional view indicating configurations of a pixel electrode and surface light-blocking layer;

FIG. 3 is a schematic view indicating a simulation result of orientation abnormality using a three-dimensional liquid crystal orientation simulator in the configuration illustrated in FIG. 2;

FIG. 4 is a characteristic view indicating the transmissivity in the cross-section along a dash line connecting between the inter-adjacent-pixel part A and the darkest luminance part B illustrated in FIG. 3(A) and FIG. 3(B); and

FIG. 5 is a schematic diagram indicating a state where a surface light-blocking layer is arranged along a generated disclination line.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Here, the explanation is given in the following order.

1. Premise technique
2. Configuration example of liquid crystal display apparatus
3. Arrangement example of surface light-blocking layer
4. Simulation result of orientation abnormality

### [1. Premise Technique]

In a liquid crystal display apparatus of an active matrix driving scheme, for example, 1H reverse drive to reverse the writing polarity of each line and 1F reverse drive to write a homopolarity image signal in one field are performed. Regarding the 1F reverse drive out of these, it is known that, since a voltage of the same sign is applied to all pixel electrodes, the influence of a horizontal electric field between pixel electrodes is removed such that it is possible to improve a loss of transmissivity and an optical leakage due to disclination (i.e. liquid crystal orientation abnormality).

However, even in a case where the 1F reverse drive is employed, when an adjacent pixel has a different potential from that of a reference pixel, there is a case where the liquid crystal orientation abnormality may be partially caused by the horizontal electric field generated by the potential difference. Especially, in a liquid crystal display apparatus with a small pixel size such as a micro LCD used for a projector, since the percentage of the liquid crystal orientation abnormality area occupied to one pixel is large, the influence is large.

Further, in a liquid crystal display of the vertical orientation type (VA scheme), the liquid crystal orientation restriction force in the horizontal direction (i.e. in-plane direction) is small. Therefore, in the liquid crystal display of the vertical orientation type, since the orientation azimuth shifts from an intended angle due to the horizontal potential difference between adjacent pixels to which different potentials are applied, a problem that a disclination is generated unfortunately occurs. By such a disclination, a black line enters the boundary between pixels, and thereby a character or the like is caused to be displayed fatter than in reality.

Also, in a three-board scheme combining three panels in total for G (Green), R (Red) and B (Blue), to make the angle of visibility uniform is achieved by making the left evaporant and the right evaporant exist together in the three panels. However, when orientation abnormality is generated due to the disclination, there may cause: a surface grainy feeling at the time of Ichimatsu pattern projection due to the level difference between the left evaporant and the right evaporant; and color symptoms at the time of displaying a three-board stripe. This tendency remarkably appears especially in a high-definition device and a narrow-pitch device.

Similarly, in the liquid crystal display apparatus used for a projector, the three-board scheme combining three panels in total for G, R and B is general, and, in this case, there is known a method of improving the homogeneity of the angle of visibility by combining panels with different orientation restriction directions. However, if the orientation abnormality area is caused between panels with different orientation restriction directions, due to the level difference, a problem unfortunately occurs that an unrequested coloring or the like is caused on the edge part of an image or character at the time of projection.

Therefore, with respect to the orientation abnormality by a horizontal electric field from an adjacent pixel, by optimizing a layout of a surface light-blocking layer (i.e. a metal layer of the lower layer of an ITO electrode) immediately below a pixel electrode having a pixel potential, it is requested to reduce the generation area of the orientation abnormality and realize a liquid crystal display apparatus with high display grade.

### [2. Configuration Example of Liquid Crystal Display Apparatus]

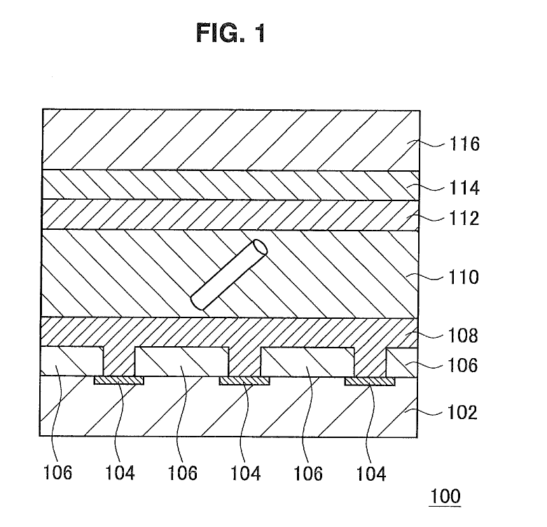

First, with reference to FIG. 1, a configuration of a liquid crystal display apparatus 100 according to the first embodiment of the present disclosure is explained.

FIG. 1 is a rough cross-sectional view indicating the configuration of the liquid crystal display apparatus 100. As illustrated in FIG. 1, liquid crystal display apparatus 100 is formed sequentially including a lower substrate (TFT substrate) 102, a surface light-blocking layer 104, a pixel electrode 106, an orientation film 108, a liquid crystal layer 110, an orientation film 112, an opposing electrode (or common electrode) 114 and an upper substrate (or opposing substrate) 116.

As an example, the liquid crystal display apparatus 100 according to the present embodiment is based on HTPS (High Temperature Poly-Silicon) and is driven by the VA scheme. Also, the liquid crystal display apparatus 100 is applicable to both the reflection-type liquid crystal display element and the transmissive liquid crystal display element as disclosed in Japanese Patent Laid-Open No. 2005-274665.

As illustrated in FIG. 1, in the liquid crystal display apparatus 100, a liquid crystal (with negative dielectric anisotropy) is enclosed between a pair of opposing substrates (i.e. the TFT substrate 102 and the opposing substrate 116), and the liquid crystal layer 110 as a light modulation layer is formed by this enclosed liquid crystal.

The TFT substrate 102 includes translucent materials such as quartz, glass, and plastic, and the surface light-blocking layer 104 and the pixel electrode 106 are formed on the inner surface side closer to the side of the liquid crystal layer 110 than the TFT substrate 102. As for the surface light-blocking layer 104 and the pixel electrode 106, multiple items are arranged and formed in a matrix manner. The pixel electrode 106 includes a transparent conductive film such as ITO, and its planar shape is formed in a substantially square shape.

The orientation film 108 is formed so as to cover the pixel electrode 106. The orientation film 108 is a vertical orientation film formed by a SiO₂ oblique deposition method. Here, in the present embodiment, although the TFT substrate 102 is provided as a TFT array substrate in which switching elements such as a TFT (Thin Film Transistor) and various wirings such as a data line and a scanning line are formed, illustration of these elements and wirings is omitted in FIG. 1.

Meanwhile, the opposing electrode (or common electrode) 114 including a transparent conductive film such as ITO is formed on the inner surface side closer to the side of the liquid crystal layer 110 than the opposing substrate 116. The opposing substrate 116 includes transmittance materials such as quartz, glass and plastic. The orientation film 112 is formed on the side of the liquid crystal layer 110 of the opposing electrode 114 so as to cover the opposing electrode 114. The orientation film 112 is a vertical orientation film formed by the SiO₂ oblique deposition method.

The orientation film 108 and the orientation film 112 control the array direction of liquid crystals of the liquid crystal layer 110. The orientation film 108 and the orientation film 112 are vertical orientation films formed by the SiO₂ oblique deposition method, the orientation restriction force in one axis direction is provided individually and the orientation restriction directions are antiparallel to each other.

Also, a liquid crystal display apparatus projector according to the present embodiment includes three liquid crystal display apparatuses 100 corresponding to R (Red), G (Green) and B (Blue), and the liquid crystal display apparatus 100 of each color performs projection corresponding to each color on a screen.

### [3. Arrangement Example of Surface Light-Blocking Layer]

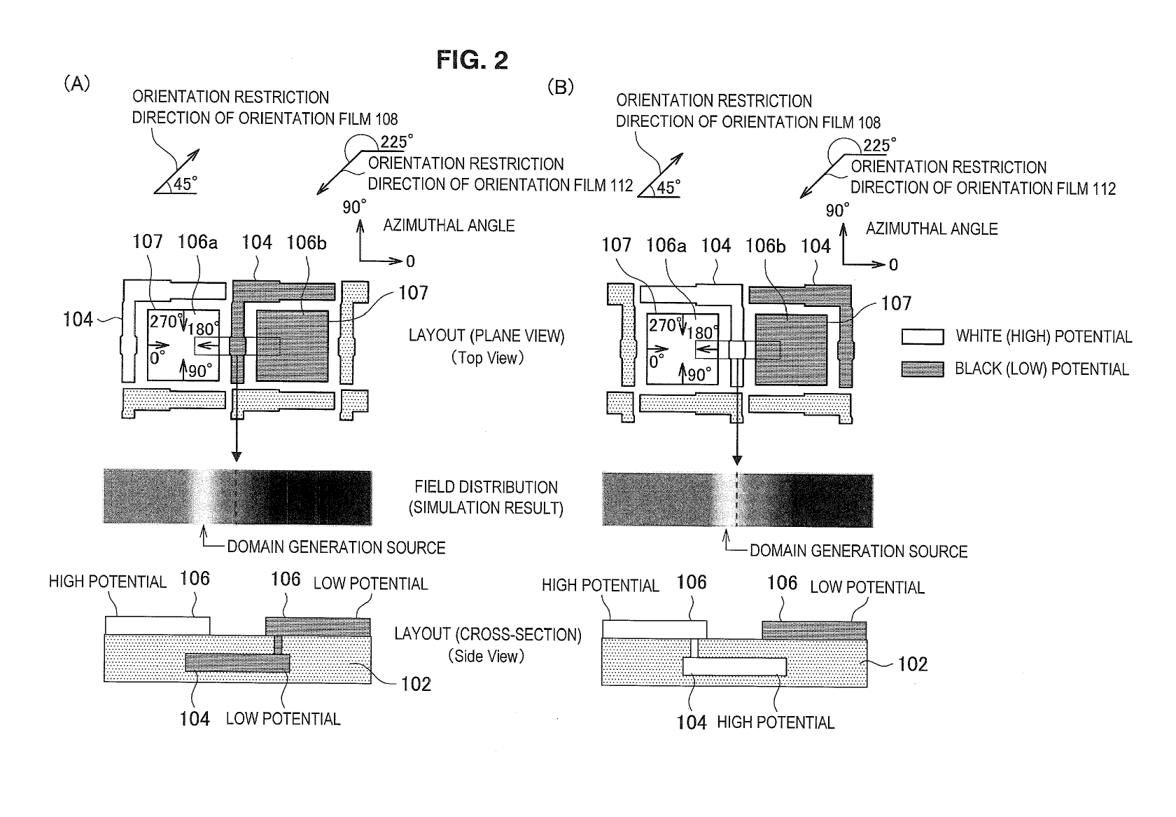

FIG. 2 is a view indicating field distribution and a plane view and cross-sectional view indicating configurations of the pixel electrode 106 and the surface light-blocking layer 104. Here, FIG. 2(A) illustrates a configuration before measurement according to the present embodiment, as a comparison example. Also, FIG. 2(B) illustrates a configuration after the measurement according to the present embodiment. The cross-sectional views illustrated in FIG. 2(A) and FIG. 2(B) illustrate the cross-sectional views of the boundary part between adjacent pixel electrodes. Here, in the plane view in FIG. 2, for each of illustration, the pixel electrode 106a and the surface light-shielding film 104 do not overlap and the pixel electrode 106b and the surface light-shielding film 104 do not overlap, but, as illustrated in the plane view in FIG. 2 or following FIG. 5, the pixel electrode 106a and the surface light-shielding film 104 overlap and the pixel electrode 106b and the surface light-shielding film 104 overlap.

As illustrated in the plane view in FIG. 2, as an azimuthal angle, it is defined that the right horizontal direction is 0 degree and the vertical direction counterclockwise therefrom is 90 degrees. In the orientation film 108, the 45-degree azimuth (i.e. the upper right direction in FIG. 2) is the orientation restriction direction and, in the orientation film 112, the 225-degree azimuth (i.e. the left lower direction in FIG. 2) is the orientation restriction direction.

In FIG. 2, when the pixel electrode 106a in one arbitrary pixel is focused on, the normal lines directed from four pixel edge parts 107 of the pixel electrode 106a to the pixel are 0 degree, 90 degrees, 180 degrees and 270 degrees on the left side, the lower side, the right side and the upper side, respectively. These directions denote the orientation restriction directions caused by the electric field distortion of the pixel edge parts 107 or denote the orientation restriction directions caused by the adjacent pixel potential in a case where the potential of the adjacent pixel is small. Therefore, in a case where the potential of the pixel electrode 106b adjacent to the pixel electrode 106a is small, it follows that the orientation restriction force is caused in the normal line direction of the right side (i.e. 180 degrees) of the pixel electrode 106a.

Here, as the difference becomes larger between the orientation restriction direction of the side of each pixel edge part 107 and the orientation restriction direction assigned to the orientation film 108 covering the pixel electrode 106, an abnormal orientation becomes more likely to be generated in the pixel edge part 107. Especially, in a case where the orientation restriction direction of the pixel edge part 107 and the orientation restriction direction assigned to the orientation film 108 are different by 90 degrees or more, the abnormal orientation caused in the pixel edge part 107 becomes remarkable.

In FIG. 2(A) and FIG. 2(B), the orientation restriction direction on the right side of the pixel electrode 106a and the orientation restriction direction of the orientation film 108 are different by 90 degrees or more. Similarly, the orientation restriction direction on the upper side of the pixel electrode 106a and the orientation restriction direction of the orientation film 108 are different by 90 degrees or more. Therefore, in a case where the potential of the pixel electrode (i.e. the pixel electrode 106b) positioned on the right side of the pixel electrode 106a or the potential of the pixel electrode positioned on the upper side is lower than the potential of the pixel electrode 106a, the abnormal orientation caused in the pixel edge part 107 on the right side or upper side of the pixel electrode 106a becomes remarkable. Similarly, in a case where the potential of the pixel electrode positioned on the upper side of the pixel electrode 106a is lower than the potential of the pixel electrode 106a, the abnormal orientation caused in the pixel edge part 107 on the upper side of the pixel electrode 106a becomes remarkable.

Meanwhile, in a case where the potential of the pixel electrode 106 adjacent to the left side or lower side of the pixel electrode 106a is lower, the orientation restriction direction on the left side or lower side of the pixel electrode 106a and the orientation restriction direction of the orientation film 108 are different by 90 degrees or less. Therefore, a large orientation abnormality is not caused in the pixel edge part 107 on the left side or lower side of the pixel electrode 106a.

In order to analyze a generation factor of this abnormal orientation in more detail, using an electric field simulator, the layout influence of the surface light-blocking layer 104 is considered in detail in addition to the potential difference influence between pixel electrodes 106. Here, in the surface light-blocking layer 104, it is assumed to have pixel potential similar to that of the pixel electrode 106. In the following, an explanation is mainly given to the orientation abnormality in the pixel edge part 107 on the right side of the pixel electrode 106a.

The plane view and cross-sectional view in FIG. 2(A) illustrate a structure in which the pixel potential on the low potential side is supplied to the surface light-blocking layer 104 positioned immediately below an area between the pixel electrode 106a and the pixel electrode 106b which are adjacent to each other. To be more specific, they illustrate a structure in which the pixel electrode 106a has high potential, the pixel electrode 106b has low potential and the surface light-blocking layer 104 immediately below the area between the pixel electrode 106a and the pixel electrode 106b has the same low potential as that of the pixel electrode 106b. Also, the simulation result of the field distribution of FIG. 2(A) shows a simulation result of the field distribution near the pixel potential in an area including the boundary neighborhood between the pixel electrode 106a and the pixel electrode 106b.

Also, the plane view and cross-sectional view in FIG. 2(B) illustrate a structure in which the pixel potential on the high potential side is supplied to the surface light-blocking layer 104 positioned immediately below the area between the pixel electrode 106a and the pixel electrode 106b which are adjacent to each other. To be more specific, they illustrate a structure in which the pixel electrode 106a has high potential, the pixel electrode 106b has low potential and the surface light-blocking layer 104 immediately below the area between the pixel electrode 106a and the pixel electrode 106b has the same high potential as that of the pixel electrode 106b. Also, the simulation result of the field distribution of FIG. 2(B) shows a simulation result of the field distribution in an area including the boundary neighborhood between the pixel electrode 106a and the pixel electrode 106b.

As illustrated in FIG. 2, in a case where the pixel potential on the high potential side is supplied to the surface light-blocking layer 104 positioned immediately below an area between adjacent pixel electrodes 106a and 10b (FIG. 2(B)), compared to a case where the pixel potential on the low potential side is applied to the surface light-blocking layer 104 (FIG. 2(A)), it is turned out that the field distribution corresponding to a factor of orientation abnormality varies. To be more specific, in the case of FIG. 2(B) in which the pixel potential on the high potential side is applied to the surface light-blocking layer 104, the generation source of disclination (i.e. disorder of the liquid crystal orientation) moves right compared to FIG. 2(A). Therefore, it is possible to change the potential boundary (i.e. domain generation source) between the adjacent pixel electrodes 106a and 106b in the liquid crystal layer 110, according to the potential of the surface light-blocking layer 104 positioned immediately below the area between the pixel electrodes 106a and 106b.

### [4. Simulation Result of Orientation Abnormality]

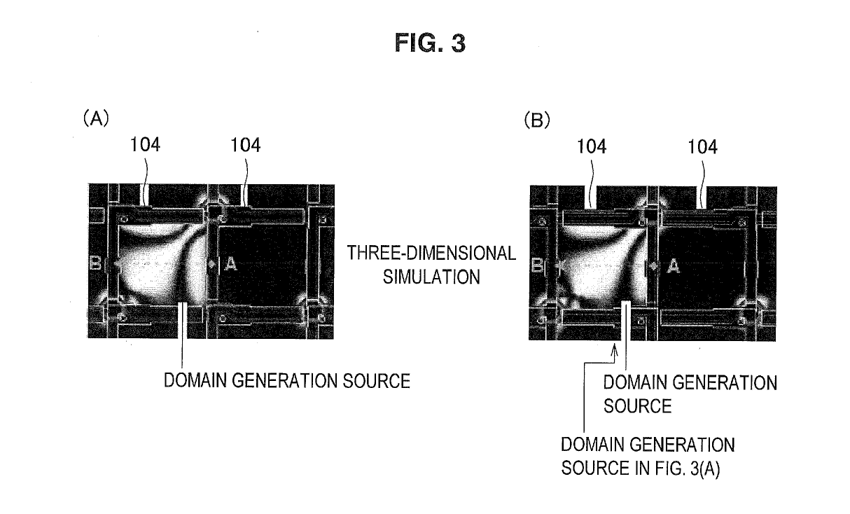

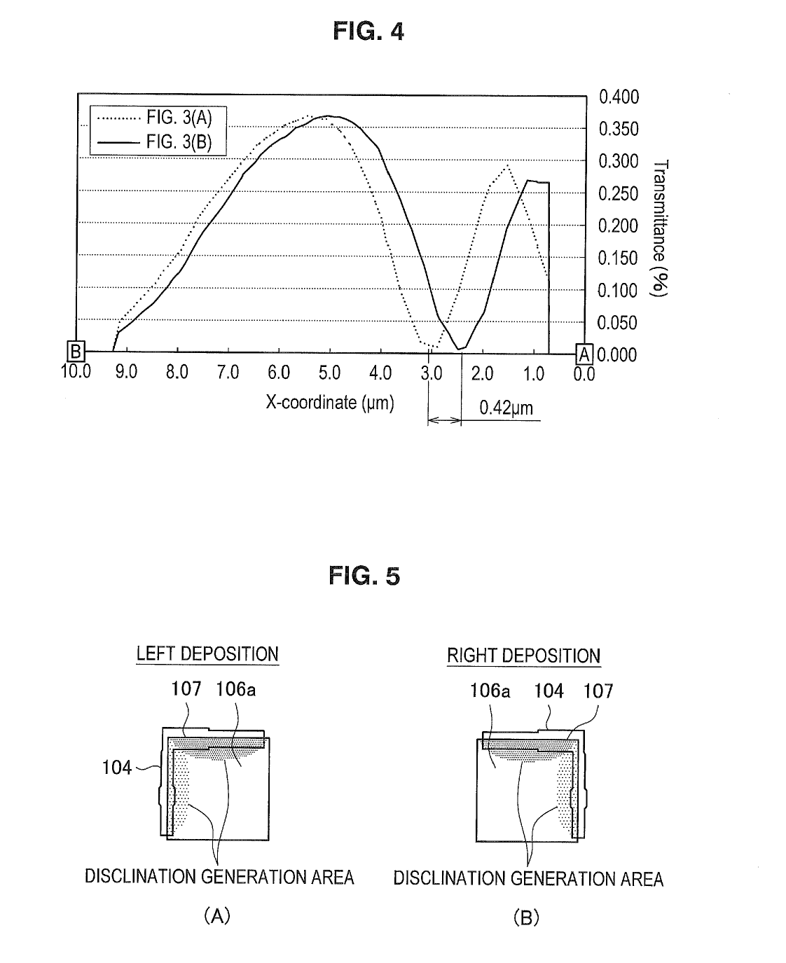

FIG. 3 is a schematic view indicating a simulation result of orientation abnormality using a three-dimensional liquid crystal orientation simulator in the configuration illustrated in FIG. 2. Here, FIG. 3(A) illustrates a simulation result corresponding to the plane view in FIG. 2(A). Also, FIG. 3(B) illustrates a simulation result corresponding to the plane view in FIG. 2(B). In FIG. 3(A) and FIG. 3(B), a white part shows an area in which the light emission luminance is high, and a black part shows an area in which the light emission luminance is low. Similar to FIG. 2(A) and FIG. 2(B), FIG. 3(A) and FIG. 3(B) show simulation results in a case where the pixel electrode 106a has high potential and the pixel electrode 106b has low potential.

In the case of FIG. 2(B) in which the high potential is applied to the surface light-blocking layer 104 between the adjacent pixel electrodes 106a and 106b, as illustrated in FIG. 3(B), compared to FIG. 3(A), the domain generation point (i.e. black-line area) moves more right. Accordingly, by applying high potential to the surface light-blocking layer 104 between the pixel electrode 106a and 106b as illustrated in FIG. 2(B), since the domain generation point becomes closer to the pixel edge part 107 of the pixel electrode 106a, it is possible to reliably suppress the degradation of images due to the domain generation.

FIG. 4 is a characteristic view indicating the transmissivity in the cross-sectional along a dash line connecting between the inter-adjacent-pixel part A and the darkest luminance part B illustrated in FIG. 3(A) and FIG. 3(B), where the characteristic of the solid line corresponds to FIG. 3(A) and the characteristic of the dash line corresponds to FIG. 3(B).

As illustrated in FIG. 4, using the distance D from the inter-adjacent-pixel part A to the darkest luminance part B by orientation abnormality as a quantification index, a simulation is run by the transmissivity profile for the cross-sectional view along the dash line in FIG. 3(A) and FIG. 3(B). According to this, in the characteristic of FIG. 2(B) illustrated by the solid line in FIG. 4, compared to the characteristic of FIG. 2(A) illustrated by the dash line in FIG. 4, it is found that the orientation abnormality area is reduced by about 0.42 um. This is because the potential boundary corresponding to the generation source of the orientation abnormality becomes closer to the area of the surface light-blocking layer 104 according to variation of the field distribution by the potential applied to the surface light-blocking layer 104.

As explained above, in one arbitrary pixel (i.e. pixel electrode 106a), in a case where the potential of the adjacent pixel electrode 106 is low, the orientation restriction directions in four sides of the pixel edge parts 107 are 0 degree, 90 degrees, 180 degrees and 270 degrees on the left side, the lower side, the right side and the upper side, respectively. Along a side in which this orientation restriction direction and the orientation restriction direction assigned to the orientation film 108 covering the pixel electrode 106 are different by 90 degrees or more, by supplying the potential equal to that of the pixel electrode 106a to the surface light-blocking layer 104 positioned immediately below the area between the adjacent pixel electrodes 106, it is possible to greatly reduce the abnormal orientation area.

In other words, in the pixel, along the disclination line generated in the direction depending on the deposition azimuth of the orientation film 108, a metal layer (i.e. the surface light-blocking layer 104) of the lower layer of the ITO electrode to which the white display potential is applied is arranged. By this mechanism, a change occurs in the horizontal electric field state between adjacent pixels to which different potentials are applied, and, since the equipotential boundary is in a state where it is more separated from the white display pixel (i.e. the pixel electrode 106a) to the black display pixel side (the pixel electrode 106b), it is possible to improve the visibility of the disclination line.

Also, by optimizing (reversing) the layout of the surface light-blocking layer 104 according to the deposition azimuth, it is possible to improve the disclination according to the deposition azimuth. The plane configuration illustrated in FIG. 2(B) indicates an example of the right deposition in a case where the orientation restriction direction of the orientation film 108 is 45 degrees, and, in this case, it is possible to improve the disclination by arranging the surface light-shielding film 104 in the shape of the plane configuration illustrated in FIG. 2(B) and providing the same high potential as that of the pixel electrode 106a corresponding to the center. Meanwhile, in a case where the orientation restriction direction of the orientation film 108 is 135 degrees, it is possible to improve the disclination by employing a configuration of the left deposition illustrated in FIG. 2(A) for the surface light-shielding film 104 and making the potential of the surface light-shielding film 104 equal to that of the pixel electrode 106a corresponding to the center. By this mechanism, in the three-board scheme combining three panels in total for G, R and B, the disclination line level difference between right and left evaporants is improved such that it is possible to achieve an improvement of the surface grainy feeling in the Ichimatsu pattern and coloring in the three-board stripe.

Therefore, in a case where the disclination line appears in the pixel edge parts 107 on the upper side and left side of the pixel electrode 106a (i.e. in a case where the orientation restriction direction of the orientation film 108 is 135 degrees), arrangement for the left deposition is assumed as illustrated in FIG. 5(A) and the surface light-blocking layer 104 is arranged along the pixel edge parts 107 on the upper side and left side of the pixel electrode 106a. Meanwhile, in a case where the disclination line appears in the pixel edge parts 107 on the right side and upper side of the pixel electrode 106a, arrangement for the right deposition is assumed as illustrated in FIG. 5(B) and FIG. 2(B), and the surface light-blocking layer 104 is arranged along the pixel edge parts 107 on the right side and upper side of the pixel electrode 106a. Thus, by arranging the surface light-blocking layer 104 along the generated disclination line and setting it to the same potential as the pixel electrode 106a at the center, it is possible to greatly improve the disclination.

Also, in a liquid crystal display apparatus used for a projector, by using the method according to the present embodiment and individually optimizing a layout of the surface light-blocking layer 104 in panels with different orientation restriction directions, it is possible to improve the symptom that an unrequested coloring occurs on the edge part of an image or character at the time of projection.

By applying the present embodiment, since it is possible to reduce the generation area of orientation abnormality due to the horizontal electric field from the adjacent pixel electrode 106b, it is possible to realize a liquid crystal display apparatus with high display grade. Also, with reduction of the orientation abnormality according to the present embodiment, it is possible to improve the pre-tilt design freedom degree and realize high CR, tilt reduction, and so on.

Also, the present embodiment is not limited to the above example, and various changes, improvements and combinations are possible on the basis of the principle of the present embodiment. In the present embodiment, the present embodiment is applicable to the large-scale or medium-scale liquid crystal display apparatus used for TV or portable display terminal having the pixel electrodes 106 of various shapes, and, even in a reflection-type liquid crystal display apparatus, application and optimization by the same principle are possible.

As explained above, according to the present embodiment, along a side in which the orientation restriction direction of the pixel edge part 107 on each side of the pixel electrode 106 and the orientation restriction direction assigned to the orientation film 108 covering the pixel electrode 106 are greatly different, by supplying the potential equal to that of the pixel electrode 106 to the surface light-blocking layer 104 positioned immediately below the area between the adjacent pixel electrodes 106, it is possible to greatly reduce the abnormal orientation area. Therefore, it is possible to minimally suppress the symptom that an unrequested coloring occurs in the edge part of an image or character.

Although a preferred embodiment of the present disclosure has been explained in detail with reference to the accompanying drawings, the technical scope of the present disclosure is not limited to such an example. It is clear that those skilled in the art of the present disclosure can conceive of various alternation examples or modification examples recited in the claims, and it is understood that these naturally belong to the technical scope of the present disclosure.

Additionally, the present technology may also be configured as below.

(1) A liquid crystal display apparatus including:

first and second substrates configured to be arranged in a manner that the first and second substrates face each other;

a vertical-orientation-type liquid crystal layer configured to be enclosed between the first and second substrates;

pixel electrodes configured to be installed on a side of the liquid crystal layer on the first substrate;

an orientation film configured to be installed in a manner that the orientation film covers the side of the liquid crystal layer of the pixel electrodes and has a predetermined orientation restriction direction; and

a surface light-blocking layer configured to be installed on a lower layer of an area between the pixel electrodes which are adjacent to each other, to be installed along a side in which a normal line direction, which is set on a side of one of the pixel electrodes and directed to a center of the pixel electrode, and the orientation restriction direction of the orientation film are different by 90 degrees or more, and to be set to a same potential as the pixel electrode.

(2) The liquid crystal display apparatus according to (1), wherein the surface light-blocking layer is installed in an L-shaped manner along two sides in which the normal line direction and the orientation restriction direction are different by 90 degrees or more.
(3) A liquid crystal projector including:

the liquid crystal display apparatus according to (1) or (2), the liquid crystal display apparatus supporting each of red, green and blue colors.

The present disclosure contains subject matter related to that disclosed in Japanese Priority Patent Application JP 2012-183119 filed in the Japan Patent Office on Aug. 22, 2012, the entire content of which is hereby incorporated by reference.

What is claimed is:

1. A liquid crystal display apparatus comprising:
first and second substrates configured to be arranged in a manner that the first and second substrates face each other;
a vertical-orientation-type liquid crystal layer configured to be enclosed between the first and second substrates;
pixel electrodes configured to be installed on a side of the liquid crystal layer on the first substrate;
an orientation film configured to be installed in a manner that the orientation film covers the side of the liquid crystal layer of the pixel electrodes and has a predetermined orientation restriction direction; and
a surface light-blocking layer configured to be installed on a lower layer of an area between the pixel electrodes which are adjacent to each other, to be installed along a side in which a normal line direction, which is set on a side of one of the pixel electrodes and directed to a center of the pixel electrode, and the orientation restriction direction of the orientation film are different by 90 degrees or more, and to be set to a same potential as the pixel electrode.

2. The liquid crystal display apparatus according to claim 1, wherein the surface light-blocking layer is installed in an L-shaped manner along two sides in which the normal line direction and the orientation restriction direction are different by 90 degrees or more.

3. A liquid crystal projector comprising:
the liquid crystal display apparatus according to claim 1, the liquid crystal display apparatus comprising each of red, green and blue colors.
